(19) United States
(12) Patent Application Publication
(10) Pub. No.: US 2013/0309569 A1
(43) Pub. Date: Nov. 21, 2013

(54) SECONDARY BATTERY

(71) Applicant: Akira Tsujiko, Toyota-shi (JP)

(72) Inventor: Akira Tsujiko, Toyota-shi (JP)

(21) Appl. No.: 13/983,320

(22) PCT Filed: Feb. 4, 2011
(86) PCT No.: PCT/JP2011/052421

§ 371 Date: Aug. 2, 2013

(51) Int. Cl. H01M 10/04

(52) U.S. Cl. CPC H01M 10/0431
USPC 429/211

(57) ABSTRACT

A negative electrode active material layer (243) of a lithium-ion secondary battery (100) has a region (243a) facing a positive electrode active material layer (223) and regions (243b1), (243b2) not facing the positive electrode active material layer (223). Therein, the equilibrium potential Ea of the region (243a) facing the positive electrode active material layer (223) is higher than the equilibrium potential Eb of the regions (243b1), (243b2) not facing the positive electrode active material layer (223) (Ea>Eb).

### TECHNICAL FIELD

The present invention relates to secondary batteries.

In the present description herein, the term “secondary battery” refers to a repeatedly chargeable storage device in general, and it is a term that encompasses what is called storage batteries, such as lithium-ion secondary batteries, lithium metal secondary batteries, nickel-metal hydride (Ni—MH) batteries, and nickel-cadmium (Ni—Cd) rechargeable batteries, as well as electrical storage devices such as electric double-layer capacitors.

In the present description, the term “lithium ion secondary battery” refers to a secondary battery in which lithium ions are used as electrolyte ions and charging and discharging are implemented by the transfer of electrons accompanying lithium ions between positive and negative electrodes.

### BACKGROUND ART

Regarding secondary batteries, Patent Document 1, for example, discloses an invention related to a cylindrical secondary battery. The secondary battery has a positive electrode comprising a positive electrode active material layer formed by coating a positive electrode active material on both sides of a strip-shaped positive electrode current collector, and a negative electrode comprising a negative electrode active material layer formed by coating a negative electrode active material on both sides of a strip-shaped negative electrode current collector. The positive electrode and the negative electrode are wound together with a separator made of a polypropylene film interposed therebetween, to form a wound electrode assembly. In Patent Literature 1, the positive electrode active material layer is referred to as the “positive electrode mixture layer”. The negative electrode active material layer is referred to as the “negative electrode mixture layer”.

This type of wound electrode assembly is accommodated in a battery case with insulators placed above and below the wound electrode assembly. In that case, in order to prevent lithium from depositing during charge and causing a short circuit in the battery, the negative electrode, which is opposed to the positive electrode, is formed to be greater width and length than the positive electrode. This type of secondary battery has, at each of the innermost edge portion and the outermost edge portion of the wound electrode assembly, a region in which the negative electrode active material layer and the positive electrode active material layer do not face each other.

According to Patent Document 1, in this type of secondary battery, lithium ions (Li⁺) diffuse into the region in which the negative electrode active material layer and the positive electrode active material layer do not face each other, causing the battery capacity to deteriorate. In view of this problem, Patent Document 1 discloses that the region of the negative electrode active material layer that does not face the positive electrode active material layer of the wound electrode assembly is coated with an insulative resin that does not dissolve in the electrolyte solution. Thereby, the coated region is kept in such a condition that it is not involved in the reaction with the electrolyte solution during charge of the battery. Therefore, lithium ions are prevented from diffusing into the region in which the negative electrode active material layer and the positive electrode active material layer do not face each other. Such description is given in, for example, paragraphs 0030 and 0041 of Patent Document 1.

Patent Document 2 does not directly relate to Patent Document 1. Patent Document 2 discloses a secondary battery in which the negative electrode active material layer is made wider than the positive electrode active material layer, for the purpose of preventing deposition of metallic lithium. In the secondary battery disclosed in the document, the negative electrode active material layer is stacked over the positive electrode active material layer so as to cover the positive electrode active material layer, with a separator interposed between the positive electrode active material layer and the negative electrode active material layer. With such a secondary battery, when, for example, lithium ions are released from positive electrode active material layer during charge, the lithium ions are absorbed in the negative electrode active material layer more reliably. Thereby, deposition of metallic lithium is prevented.

### CITATION LIST

### Patent Literature

[Patent Document 1] JP H07 (1995)-130389 A
[Patent Document 2] JP 2005-190913 A

### SUMMARY OF INVENTION

### Technical Problem

As a configuration for preventing deposition of metallic lithium, it is known to stack the negative electrode active material layer and the positive electrode active material layer one on the other while a separator is interposed between the positive electrode active material layer and the negative electrode active material layer. In such a configuration, the negative electrode active material layer may in some cases have a region facing the positive electrode active material layer and a region not facing the positive electrode active material layer. During charge, lithium ions are absorbed in the negative electrode active material layer. At this time, lithium ions can be absorbed even in the region of the negative electrode active material layer that does not face the positive electrode active material layer. During discharge, on the other hand, the lithium ions that have been absorbed in the negative electrode active material layer are released.

In this type of secondary battery, the battery capacity may in some cases decrease when charge and discharge are repeated. Theoretically, the battery capacity is higher when a greater amount of lithium ions is used for the battery reactions during charge. The present inventors believe that a factor in the decrease of the battery capacity is that part of the lithium ions becomes substantially no longer used for battery reactions.

We believe that one of the events by which part of the lithium ions becomes no longer used for the battery reactions is that lithium ions are fixed to the region of the negative electrode active material layer that does not face the positive electrode active material layer. That is, the negative electrode active material layer may contain a region that faces the positive electrode active material layer and a region that does not face the positive electrode active material layer. Due to the fact that it does not face the positive electrode active material layer, the region of the negative electrode active material layer that does not face the positive electrode active material layer releases lithium ions less easily than the region that faces the positive electrode active material layer does.

For this reason, the lithium ions having been absorbed in the region of the negative electrode active material layer that does not face the positive electrode active material layer gradually become difficult to be used in the charge and discharge of the battery. In other words, part of the lithium ions contained in the battery is substantially fixed to the region of the negative electrode active material layer that does not face the positive electrode active material layer, and becomes no longer used for the battery reactions. The part of the lithium ions that is no longer used for the battery reactions can become a factor in the decrease of the battery capacity.

### Solution to Problem

The present invention provides a secondary battery comprising a positive electrode current collector, a positive electrode active material layer retained on the positive electrode current collector, a negative electrode current collector, a negative electrode active material layer retained on the negative electrode current collector and covering the positive electrode active material layer, and a separator interposed between the positive electrode active material layer and the negative electrode active material layer. Here, the negative electrode active material layer comprises a region facing the positive electrode active material layer and a region not facing the positive electrode active material layer, and the equilibrium potential Ea of the region facing the positive electrode active material layer is higher than the equilibrium potential Eb of the region not facing the positive electrode active material layer (Ea>Eb).

In this case, the equilibrium potential Ea of the region of the negative electrode active material layer facing the positive electrode active material layer is higher than the equilibrium potential Eb of the region of the negative electrode active material layer not facing the positive electrode active material layer (Ea>Eb). As a result, lithium ions are prevented from being substantially fixed to the region of the negative electrode active material layer not facing the positive electrode active material layer. Thereby, the decrease of the battery capacity can be kept small.

In this case, in the negative electrode active material layer, the region facing the positive electrode active material layer and the region not facing the positive electrode active material layer may comprise different negative electrode active materials. In addition, the equilibrium potential Ea may be higher than the equilibrium potential Eb when the secondary battery is within the range of state of charge in which the secondary battery can be repeatedly charged and discharged. It is possible that each of the positive electrode current collector and the negative electrode current collector may be in a strip-shaped sheet form, the positive electrode active material layer may be retained on the positive electrode current collector so as to have a predetermined area, and the negative electrode active material layer is retained on the negative electrode current collector so as to have an area wider than the positive electrode active material layer.

### BRIEF DESCRIPTION OF DRAWINGS

FIG. 1 is a view illustrating one example of the structure of a lithium-ion secondary battery.

FIG. 2 is a view illustrating a wound electrode assembly of the lithium-ion secondary battery.

FIG. 3 is a cross-sectional view taken along line III-III in FIG. 2.

FIG. 4 is a cross-sectional view illustrating the structure of a positive electrode active material layer.

FIG. 5 is a cross-sectional view illustrating the structure of a negative electrode active material layer.

FIG. 6 is a side view illustrating a portion where an uncoated portion of the wound electrode assembly is welded to an electrode terminal.

FIG. 7 is a view schematically illustrating a state of the lithium-ion secondary battery during charge.

FIG. 8 is a view schematically illustrating a state of the lithium-ion secondary battery during discharge.

FIG. 9 is a view illustrating an example of the configuration of an apparatus for obtaining a cyclic voltammogram.

FIG. 10 is a view schematically illustrating the structure of a lithium-ion secondary battery.

FIG. 11 is a view illustrating the process of forming a negative electrode active material layer.

FIG. 12 is a view illustrating an electrode material coating device.

FIG. 13 is a view schematically illustrating the structure of a laminate-type test battery.

FIG. 14 is a graph illustrating an example of measurements of equilibrium potentials for negative electrode active material layers.

FIG. 15 is a graph illustrating the process of charge-discharge cycles in an evaluation test.

FIG. 16 is a view illustrating a vehicle incorporating a secondary battery.

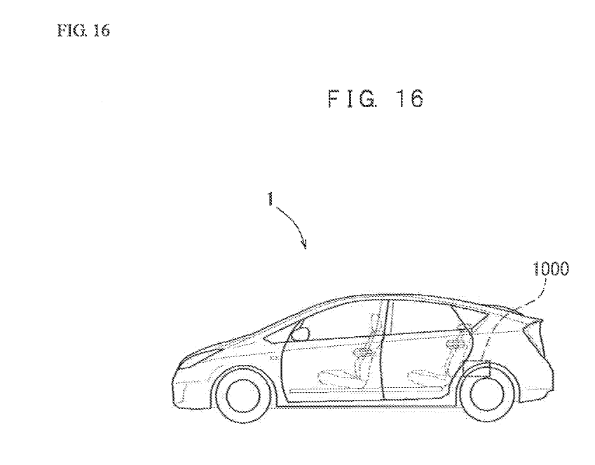

### DESCRIPTION OF EMBODIMENTS

Hereinbelow, a secondary battery according to one embodiment of the present invention will be described with reference to the drawings. Herein, the secondary battery will be described using a lithium-ion secondary battery as an example. The parts and components that exhibit the same workings are denoted by the same reference symbols as appropriate. The drawings are depicted schematically and do not necessarily reflect actual objects. The drawings merely show examples, and they do not limit the invention unless otherwise stated.

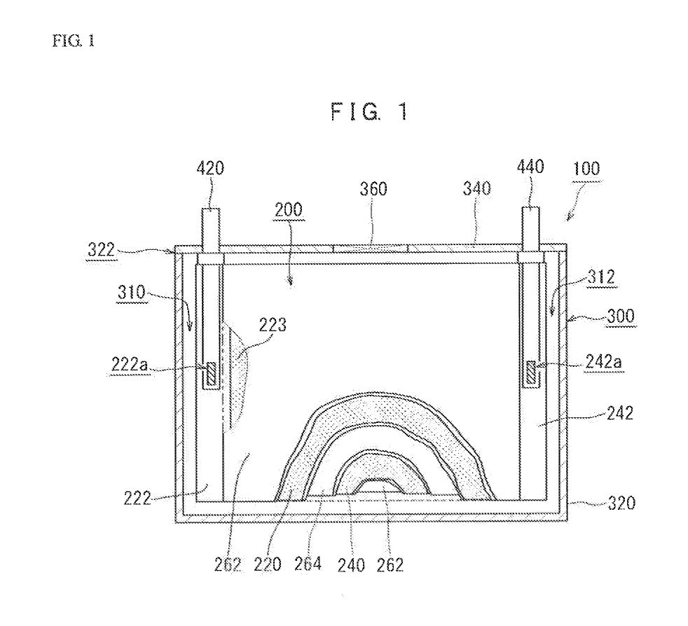

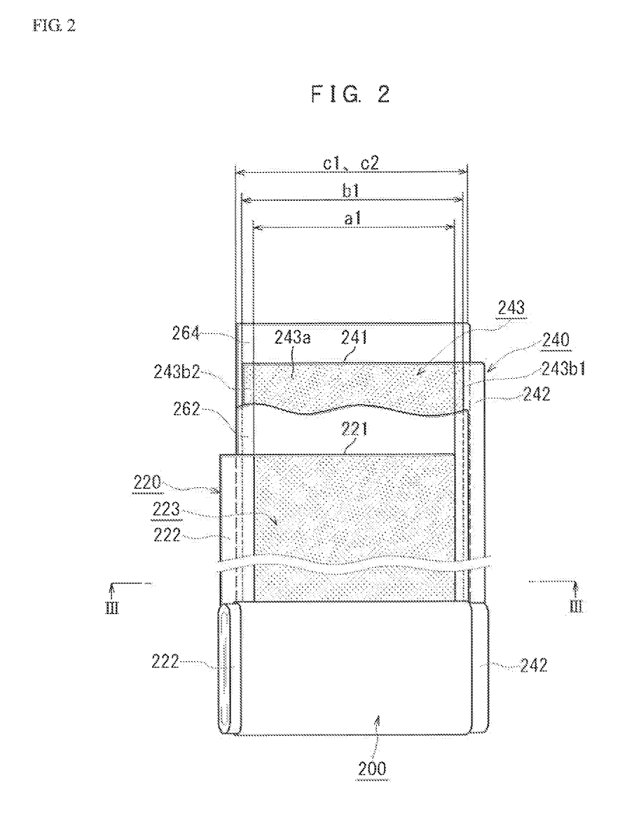

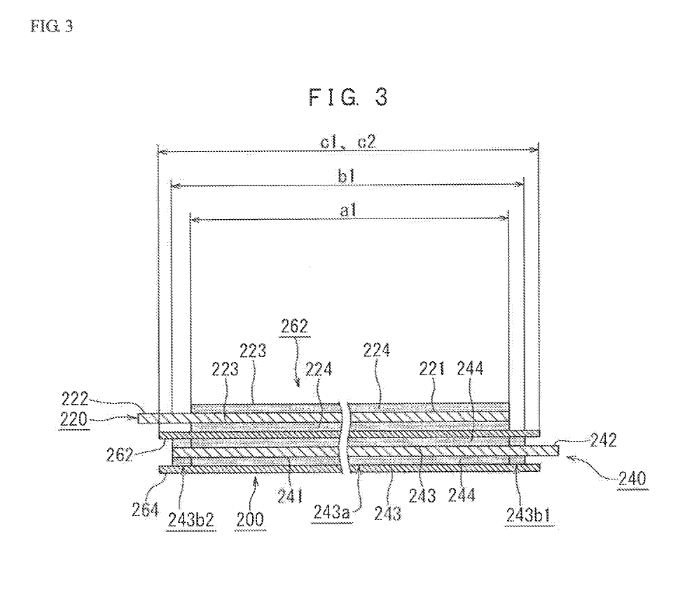

FIG. 1 illustrates a lithium-ion secondary battery 100. As illustrated in FIG. 1, the lithium-ion secondary battery 100 has a wound electrode assembly 200 and a battery case 300. FIG. 2 is a view illustrating the wound electrode assembly 200. FIG. 3 shows a cross section taken along line III-III in FIG. 2.

As illustrated in FIG. 2, the wound electrode assembly 200 has a positive electrode sheet 220, a negative electrode sheet 240, and separators 262 and 264. The positive electrode sheet 220, the negative electrode sheet 240, and the separators 262 and 264 are strip-shaped sheets.

### <<Positive Electrode Sheet 220>>

The positive electrode sheet 220 has a strip-shaped positive electrode current collector 221 (positive electrode core material), as illustrated in FIG. 2. A metal foil suitable for the positive electrode, for example, may be used preferably for the positive electrode current collector 221. A strip-shaped aluminum foil having a predetermined width is used for this positive electrode current collector 221. The positive electrode sheet 220 has an uncoated portion 222 and a positive electrode active material layer 223. The uncoated portion 222 is provided along one lateral-side edge of the positive electrode current collector 221. The positive electrode active material layer 223 is a layer containing a positive electrode active material. The positive electrode active material layer 223 is formed on both faces of the positive electrode current collector 221 except for the uncoated portion 222, which is provided in the positive electrode current collector 221.

### <<Positive Electrode Active Material Layer 223 and Positive Electrode Active Material 610>>

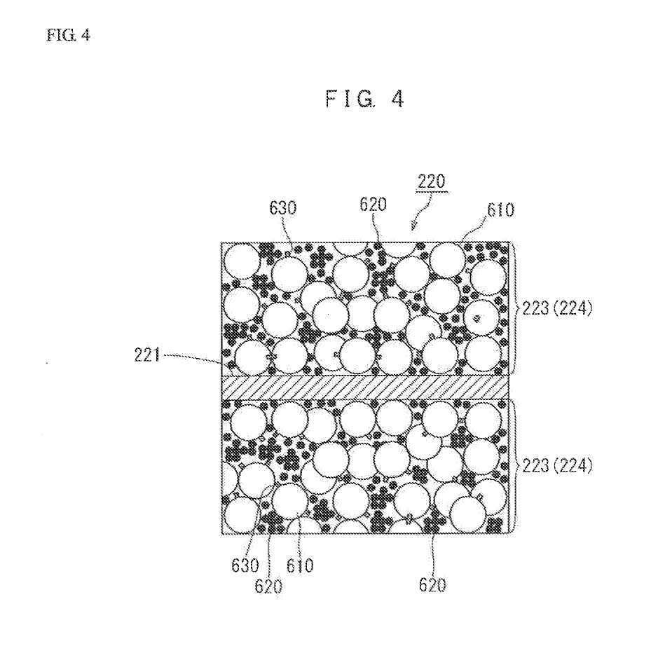

FIG. 4 is a cross-sectional view of the positive electrode sheet 220 of the lithium-ion secondary battery 100. In FIG. 4, positive electrode active material 610, conductive agent 620, and binder 630 in the positive electrode active material layer 223 are enlarged schematically in order to show the structure of the positive electrode active material layer 223 clearly. As illustrated in FIG. 4, the positive electrode active material layer 223 contains the positive electrode active material 610, the conductive agent 620, and the binder 630.

Various types of substances that can be used as the positive electrode active material of lithium-ion secondary batteries may be used for the positive electrode active material 610. Examples of the positive electrode active material include 610 lithium transition metal oxides, such as LiNiCoMnO₂ (lithium-nickel-cobalt-manganese composite oxide), LiNiO₂ (lithium nickel oxide), LiCoO₂ (lithium cobalt oxide), LiMn₂O₄ (lithium manganese oxide), and LiFePO₄ (lithium iron phosphate). Here, LiMn₂O₄ may have, for example, a spinel structure. LiNiO₂ and LiCoO₂ may have a layered rock-salt structure. LiFePO₄ may have, for example, an olivine structure. The LiFePO₄ with an olivine structure may have, for example, particles in the range of nanometers. The LiFePO₄ with an olivine structure may further be coated with a carbon film.

### <<Conductive Agent 620>>

Examples of the conductive agent include carbon materials, such as carbon powder and carbon fiber. It is possible to use one of the just-mentioned examples of the conductive agents either alone or in combination with another one or more of the examples. Examples of the carbon powder include various types of carbon blacks (such as acetylene black, oil-furnace black, graphitized carbon black, carbon black, graphite, and Ketjen Black) and graphite powder.

### <<Binder 630>>

The binder 630 serves to bond the particles of the positive electrode active material 610 and the conductive agent 620 and to bond these particles with the positive electrode current collector 221. As the binder 630, it is possible to use polymers that can be dissolved or dispersed in the solvent used. For example, for the positive electrode mixture composition using an aqueous solvent, it is possible to use water-soluble or water-dispersible polymers, examples of which include: cellulose-based polymers such as carboxymethylcellulose (CMC) and hydroxypropyl methyl cellulose (HPMC); fluoropolymers such as polyvinyl alcohol (PVA), polytetrafluoroethylene (PTFE), and tetrafluoroethylene-hexafluoropropylene copolymer (FEP); and rubber materials such as vinyl acetate copolymer, styrene-butadiene copolymer (SBR), and acrylic acid-modified SBR resin (SBR latex). For the positive electrode mixture composition using a non-aqueous solvent, it is possible to use polymers such as polyvinylidene fluoride (PVDF), polyvinylidene chloride (PVDC), and polyacrylonitrile (PAN). It is possible that the just-mentioned examples of the polymer materials may also be used for the purpose of obtaining the function as an addition agent such as a thickening agent for the above-described composition, in addition to the function as a binder.

### <<Thickening Agent and Solvent>>

The positive electrode active material layer 223 is formed, for example, in the following manner: the above-mentioned positive electrode active material 610 and the conductive agent 620 are mixed into a paste form (slurry form) in a solvent to prepare a positive electrode mixture, which is then coated onto the positive electrode current collector 221, dried, and pressure-rolled. In this case, either an aqueous solvent or a non-aqueous solvent can be used as the solvent. A preferable example of the non-aqueous solvent is N-methyl-2-pyrrolidone (NMP).

It is preferable that the mass ratio of the positive electrode active material in the entire positive electrode mixture be about 50 wt. % or more (typically from 50 wt. % to 95 wt. %), and generally more preferably from about 70 wt. % to about 95 wt. % (e.g., from 75 wt. % to 90 wt. %). The proportion of the conductive agent in the entire positive electrode mixture may be from about 2 wt. % to about 20 wt. %, and generally preferably from about 2 wt. % to about 15 wt. %. In a composition that uses a binder, the proportion of the binder in the entire positive electrode mixture may be from about 1 wt. % to about 10 wt. %, and generally preferably from about 2 wt. % to about 5 wt. %.

### <<Negative Electrode Sheet 240>>

As illustrated in FIG. 2, the negative electrode sheet 240 has a strip-shaped negative electrode current collector 241 (negative electrode core material). For the negative electrode current collector 241, a metal foil suitable for the negative electrode, for example, may be used preferably. In this embodiment, a strip-shaped copper foil having a predetermined width is used for the negative electrode current collector 241. The negative electrode sheet 240 has an uncoated portion 242 and a negative electrode active material layer 243. The uncoated portion 242 is provided along one lateral-side edge of the negative electrode current collector 241. The negative electrode active material layer 243 is a layer containing a negative electrode active material. The negative electrode active material layer 243 is formed on both faces of the negative electrode current collector 241 except for the uncoated portion 242, which is provided in the negative electrode current collector 241.

### <<Negative Electrode Active Material Layer 243>>

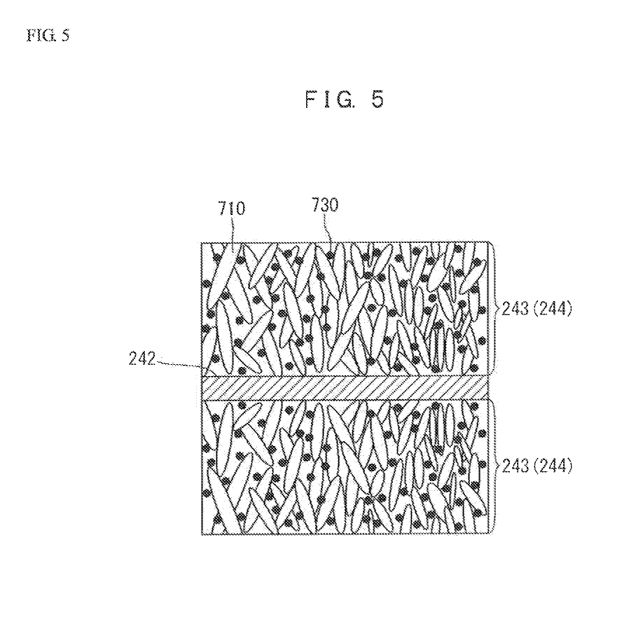

FIG. 5 is a cross-sectional view of the negative electrode sheet 240 of the lithium-ion secondary battery 100. In FIG. 5, negative electrode active material 710 and binder 730 in the negative electrode active material layer 243 are enlarged schematically in order to show the structure of the negative electrode active material layer 243 clearly. Here, the figure depicts a case in which what is called flake graphite is used as the negative electrode active material 710, but the negative electrode active material 710 is not limited to the example shown in the figure. As illustrated in FIG. 5, the negative electrode active material layer 243 contains the negative electrode active material 710, a thickening agent (not shown), and the binder 730. The negative electrode active material 710 contained the negative electrode active material layer 243 will be detailed later.

### <<Separators 262 and 264>>

Each of the separators 262 and 264 is a member for separating the positive electrode sheet 220 and the negative electrode sheet 240 from each other. In this example, each of the separators 262 and 264 is made of a strip-shaped sheet having a plurality of micropores and having a predetermined width. Examples of the separators 262 and 264 include a single layer separator and a multi-layered separator, which are made of porous polyolefin-based resin.

### <<Wound Electrode Assembly 200>>

The wound electrode assembly 200 is an electrode assembly in which the positive electrode sheet 220 and the negative electrode sheet 240 are stacked and wound with the separators 262 and 264 interposed between the positive electrode active material layer 223 and the negative electrode active material layer 243. In this embodiment, as illustrated in FIGS. 2 and 3, the positive electrode sheet 220, the negative electrode sheet 240, and the separators 262 and 264 are aligned in the same longitudinal direction and stacked in the following order: the positive electrode sheet 220, the separator 262, the negative electrode sheet 240, and the separator 264. In this embodiment, the negative electrode active material layer 243 is stacked over the positive electrode active material layer 223 so as to cover the positive electrode active material layer 223 while the separators 262 and 264 are interposed therebetween.

Moreover, the positive electrode sheet 220 and the negative electrode sheet 240 are stacked so that the uncoated portion 222 of the positive electrode sheet 220 and the uncoated portion 242 of the negative electrode sheet 240 protrude in opposite lateral directions from the separators 262 and 264. The stacked sheets (e.g., the positive electrode sheet 220) are wound around a winding axis set in a lateral direction. For the wound electrode assembly 200, the positive electrode sheet 220, the negative electrode sheet 240, and the separators 262 and 264 are stacked while controlling the positions of the sheets with a position adjusting mechanism such as EPC (edge position control) in the process of winding the positive electrode sheet 220, the negative electrode sheet 240, and the separators 262 and 264.

### <<Battery Case 300>>

In this example, as illustrated in FIG. 1, the battery case 300 is what is called a prismatic battery case, and it includes a case main body 320 and a lid 340. The case main body 320 has a closed-bottom quadrangular prismatic tubular shape, and is a flat-box-shaped case and whose one side face (upper face) is open. The lid 340 is a member that is attached to the opening of the case main body 320 (the opening in the upper face thereof) to close the opening. The case main body 320 may be formed by, for example, deep drawing or impact molding. Note that the impact molding is one type of cold forging, and is also referred to as impact extrusion or impact pressing.

The battery case 300 has a flat rectangular internal space as the space for accommodating the wound electrode assembly 200. As illustrated in FIG. 1, the flat internal space of the battery case 300 is slightly wider than the wound electrode assembly 200. In this embodiment, the wound electrode assembly 200 is accommodated in the internal space of the battery case 300. As illustrated in FIG. 1, the wound electrode assembly 200 is enclosed in the battery case 300 in such a manner that it is deformed into a flat shape in one direction perpendicular to the winding axis.

To the lid 340 of the battery case 300, electrode terminals 420 and 440 are attached. The electrode terminals 420 and 440 penetrate through the battery case 300 (the lid 340) and stick out outside the battery case 300. The lid 340 is provided with a safety vent 360.

The wound electrode assembly 200 is attached to the electrode terminals 420 and 440, which are attached to the battery case 300 (to the lid 340 in this example). The wound electrode assembly 200 is enclosed in the battery case 300 in such a manner that it is pressed into a flat shape in one direction perpendicular to the winding axis. In the wound electrode assembly 200, the uncoated portion 222 of the positive electrode sheet 220 and the uncoated portion 242 of the negative electrode sheet 240 protrude in opposite lateral directions from the separators 262 and 264. Of these, one electrode terminal 420 is fixed to the uncoated portion 222 of the positive electrode current collector 221, while the other electrode terminal 440 is fixed to the uncoated portion 242 of the negative electrode current collector 241.

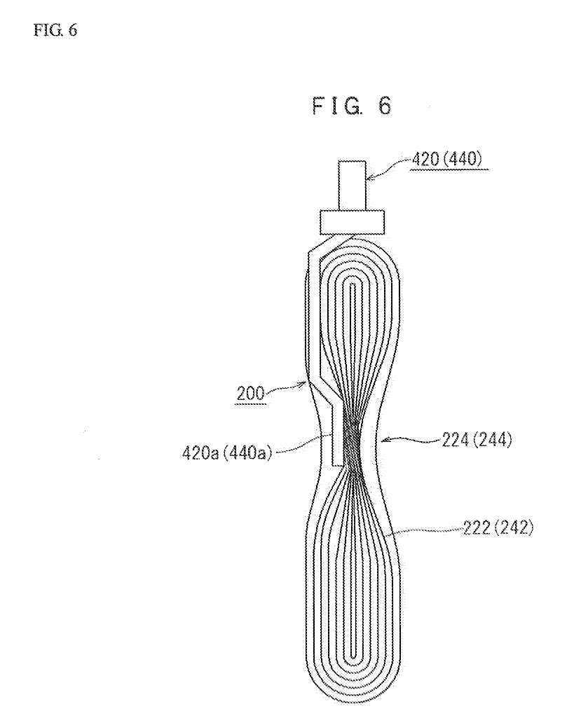

In this example, as illustrated in FIG. 1, the electrode terminals 420 and 440 in the lid 340 extend to respective intermediate portions 224 and 244 of the uncoated portion 222 and the uncoated portion 242 of the wound electrode assembly 200. As illustrated in FIG. 6, the foremost end portions 420a and 440a of the electrode terminals 420 and 440 are welded to the respective intermediate portions of the uncoated portions 222 and 242. Here, FIG. 6 is a side view illustrating the portion where the uncoated portion 222 or 242 of the wound electrode assembly 200 is welded to the electrode terminal 420 or 440.

The uncoated portion 222 of the positive electrode current collector 221 and the uncoated portion 242 of the negative electrode current collector 241 are exposed from the respective sides of the separators 262 and 264 in a spiral shape. As illustrated in FIG. 6, in this embodiment, these uncoated portions 222 and 242 are gathered at the respective intermediate portions 224 and 244 and welded to the foremost end portions 420a and 440a of the respective electrode terminals 420 and 440. In this case, from the viewpoint of the difference in materials, ultrasonic welding, for example, is used for welding the electrode terminal 420 to the positive electrode current collector 221. On the other hand, resistance welding, for example, is used for welding the electrode terminal 440 to the negative electrode current collector 241.

Thus, the wound electrode assembly 200 is attached to the electrode terminals 420 and 440 fixed to the lid 340 while it is pressed into a flat shape. The wound electrode assembly 200 is accommodated in the flat internal space of the case main body 320. The case main body 320 is closed by the lid 340 after the wound electrode assembly 200 is placed therein. A joint portion 322 (see FIG. 1) between the lid 340 and the case main body 320 is welded by, for example, laser welding. Thus, in this example, the wound electrode assembly 200 is positioned in the battery case 300 by the electrode terminals 420 and 440 fixed to the lid 340 (i.e., the battery case 300).

### <<Electrolyte Solution>>

Thereafter, an electrolyte solution is filled into the battery case 300 through a filling port provided in the lid 340. The electrolyte solution used in this example is an electrolyte solution in which LiPF₆ is contained at a concentration of about 1 mol/L in a mixed solvent of ethylene carbonate and diethyl carbonate (e.g., a mixed solvent with a volume ratio of about 1:1). Thereafter, a metal sealing cap is attached (welded, for example) to the filling port to seal the battery case 300. For the electrolyte solution, any non-aqueous electrolyte solution that has conventionally been used for lithium-ion secondary batteries may be used.

### <<Gas Release Passage>>

In this example, the flat internal space of the battery case 300 is slightly wider than the wound electrode assembly 200 deformed in a flat shape. Gaps 310 and 312 are provided between the wound electrode assembly 200 and the battery case 300 at the respective sides of the wound electrode assembly 200. Each of the gaps 310 and 312 serves as a gas release passage.

In the lithium-ion secondary battery 100 with such a configuration, the temperature rises when overcharge takes place. When the temperature of the lithium-ion secondary battery 100 rises, the electrolyte solution is decomposed, and consequently gas is generated. The generated gas can be smoothly discharged outside through the gaps 310 and 312 between the wound electrode assembly 200 and the battery case 300 at the opposite sides of the wound electrode assembly 200 and then through the safety vent 360. In the lithium-ion secondary battery 100, the positive electrode current collector 221 and the negative electrode current collector 241 of the wound electrode assembly 200 are electrically connected to an external device via the electrode terminals 420 and 440 penetrating through the battery case 300.

### <<Positive Electrode Active Material Layer 223 and Negative Electrode Active Material Layer 243>>

As illustrated in FIG. 4, in this embodiment, the positive electrode mixture is coated on both faces of the positive electrode current collector 221. Each of the positive electrode mixture layers (the positive electrode active material layers 223) contains the positive electrode active material 610 and the conductive agent 620. As illustrated in FIG. 5, the negative electrode mixture is coated on both faces of the negative electrode current collector 241. Each of the negative electrode mixture layers (the negative electrode active material layers 243) contains the negative electrode active material 710.

### <<Pore>>

In this embodiment, the positive electrode active material layer 223 has tiny gaps, which may be called voids, for example, between the particles of the positive electrode active material 610 and the conductive agent 620. The tiny gaps in the positive electrode active material layer 223 can be impregnated with the electrolyte solution (not shown). Also, the negative electrode active material layer 243 has tiny gaps, which may be called voids, for example, between the particles of the negative electrode active material 710. The tiny gaps in the negative electrode active material layer 243 can be impregnated with the electrolyte solution (not shown). Herein, such gaps (or voids) are referred to as “pores” as appropriate.

The operation of the lithium-ion secondary battery 100 during charge and during discharge will be described in the following.

### <<Operation During Charge>>

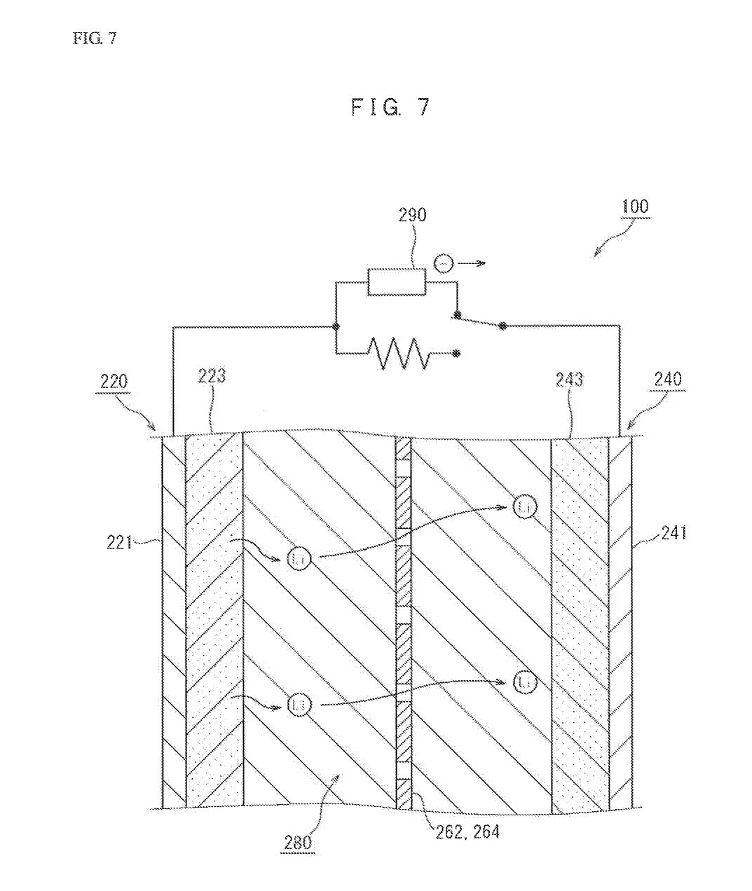

FIG. 7 schematically illustrates the state of the lithium-ion secondary battery 100 during charge. During charge, the electrode terminals 420 and 440 (see FIG. 1) of the lithium-ion secondary battery 100 are connected to a charger 290, as illustrated in FIG. 7. Due to the charger 290, during charge, lithium ions are released into the electrolyte solution 280 from the positive electrode active material 610 (see FIG. 4) within the positive electrode active material layer 223. Also, electrons are released from the positive electrode active material 610 (see FIG. 4). As illustrated in FIG. 7, the released electrons are sent via the conductive agent 620 to the positive electrode current collector 221 and further sent via the charger 290 to the negative electrode. In the negative electrode, electrons are stored, and the lithium ions in the electrolyte solution 280 are absorbed and stored in the negative electrode active material 710 (see FIG. 5) within the negative electrode active material layer 243.

### <<Operation During Discharge>>

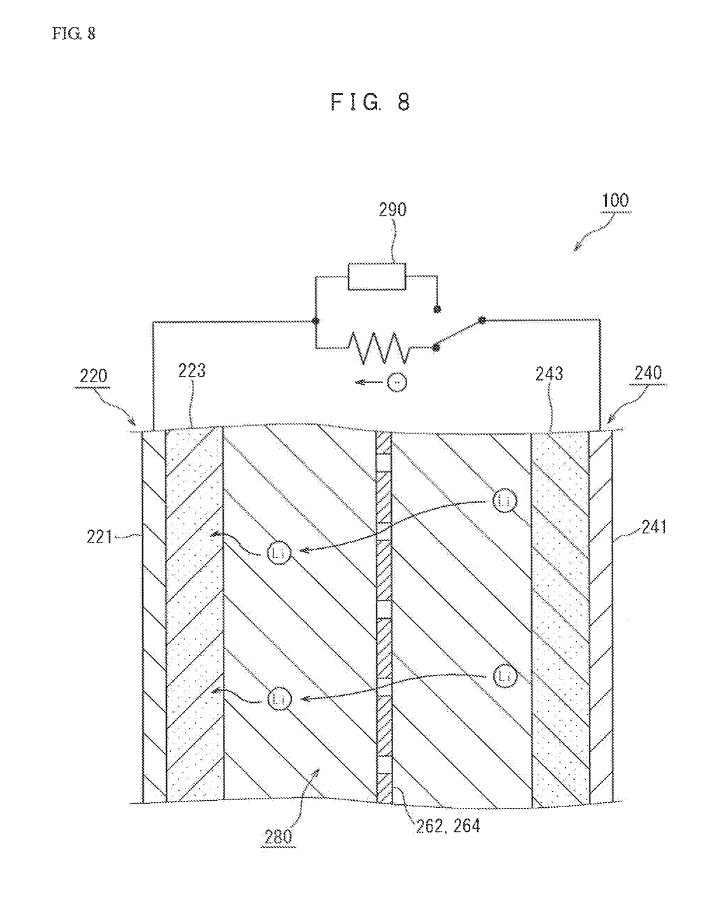

FIG. 8 schematically illustrates the state of the lithium-ion secondary battery 100 during discharge. During discharge, as illustrated in FIG. 8, electrons are transferred from the negative electrode to the positive electrode, and at the same time, the lithium ions (Li ions) stored in the negative electrode active material layer 243 are released into the electrolyte solution 280. Also, in the positive electrode, the lithium ions in the electrolyte solution 280 are absorbed into the positive electrode active material 610 within the positive electrode active material layer 223.

Thus, in the charge and discharge of the lithium-ion secondary battery 100, lithium ions are transferred back and forth between the positive electrode active material layer 223 and the negative electrode active material layer 243 via the electrolyte solution 280. For this reason, it is desirable that the positive electrode active material layer 223 has necessary pores around the positive electrode active material 610 (see FIG. 4) and around the negative electrode active material 710 (see FIG. 5) such that the electrolyte solution 280 can be impregnated sufficiently and lithium ions can diffuse smoothly. Such a configuration makes it possible to exist sufficient lithium ions around the positive electrode active material 610 and around the negative electrode active material 710. This enables smooth transfer of lithium ions between the electrolyte solution 280 and the positive electrode active material 610 and between the electrolyte solution 280 and the negative electrode active material 710.

In addition, during charge, electrons are transferred from the positive electrode active material 610 via the conductive agent 620 to the positive electrode current collector 221. On the other hand, during discharge, electrons are returned from the positive electrode current collector 610 via the conductive agent 620 to the positive electrode active material 221. The positive electrode active material 610 is made of a lithium transition metal oxide, so it is poor in electrical conductivity. For this reason, the electron transfer between the positive electrode active material 610 and the positive electrode current collector 221 mainly takes place through the conductive agent 620.

Thus, when the transfer of lithium ions and the transfer of electrons take place more smoothly during charge, it is believed possible to achieve more efficient and rapid charging. When the transfer of lithium ions and the transfer of electrons take place more smoothly during discharge, the resistance in the battery becomes lower and the amount of discharge becomes higher, so it is believed possible to improve the output power of the battery. Moreover, when the number of the lithium ions that are utilized for the battery reactions during charge and discharge is greater, the battery capacity is believed to be higher.

In the following, the negative electrode active material layer 243 of the lithium-ion secondary battery 100 will be described in more detail. In this embodiment, as illustrated in FIGS. 2 and 3, the width b1 of the negative electrode active material layer 243 is slightly wider than the width a1 of the positive electrode active material layer 223. In addition, the width c1, c2 of the separators 262 and 264 is slightly wider than the width b1 of the negative electrode active material layer 243 (c1, c2>b1>a1). The positive electrode sheet 220, the negative electrode sheet 240, and the separators 262 and 264 are stacked in the following order: the positive electrode sheet 220, the separator 262, the negative electrode sheet 240, and the separator 264. Also, the negative electrode active material layer 243 covers positive electrode active material layer 223 while the separators 262 and 264 are interposed therebetween, and the separators 262 and 264 cover the negative electrode active material layer 243.

As a result, the negative electrode active material layer 243 has a region 243a facing the positive electrode active material layer 223 and the regions 243b1 and 243b2 not facing the positive electrode active material layer 223. In this embodiment, the region 243a facing the positive electrode active material layer 223 is provided in a widthwise intermediate portion of the negative electrode active material layer 243. On the other hand, the regions 243b1 and 243b2 not facing the positive electrode active material layer 223 are provided at both widthwise sides of the negative electrode active material layer 243. Therein, the region 243b1 not facing the positive electrode active material layer 223 is provided along the uncoated portion 242 of the negative electrode active material layer 243. The region 243b2 not facing the positive electrode active material layer 223 is provided along the opposite edge to the uncoated portion 242 of the negative electrode active material layer 242.

### <<Equilibrium Potential in the Negative Electrode Active Material Layer 243>>

In this embodiment, the negative electrode active material layer 243 is such that the equilibrium potential Ea of the region 243a facing the positive electrode active material layer 223 is higher than the equilibrium potential Eb of the regions 243b1 and 243b2 not facing the positive electrode active material layer 223 (i.e., Ea>Eb).

### <<Equilibrium Potential>>

Herein, the term “equilibrium potential” refers to a potential shown in a test electrode immersed in an electrolyte solution when the reaction in which an oxidant is reduced and the reaction in which a reductant is oxidized are in an equilibrium state. The equilibrium potential is also referred to as an electrode potential.

In this embodiment, the negative electrode active material layer 243 has a region 243a in which the equilibrium potential is high, and regions 243b1 and 243b2 in which the equilibrium potential is low. In this case, during discharge, the regions 243b1 and 243b2 of the negative electrode active material layer 243, in which the equilibrium potential is lower, tend to release lithium ions more easily than the region 243a of the negative electrode active material layer 243, in which the equilibrium potential is higher. In addition, during charge, the region 243a of the negative electrode active material layer 243, in which the equilibrium potential is higher, tends to absorb lithium ions more easily than the regions 243b1 and 243b2 of the negative electrode active material layer 243, in which the equilibrium potential is lower. Moreover, a phenomenon is observed that lithium ions are substantially transferred from the regions 243b1 and 243b2 of the negative electrode active material layer 243, in which the equilibrium potential is lower, to the region 243a thereof, in which the equilibrium potential is higher.

In other words, during discharge, the regions 243b1 and 243b2 not facing the positive electrode active material layer 223 (i.e., the regions in which the equilibrium potential is lower) tend to release lithium ions more easily than the region 243a facing the positive electrode active material layer 243 (i.e., the region in which the equilibrium potential is higher). In addition, during charge, the region 243a facing the positive electrode active material layer 223 tends to absorb lithium ions more easily than the regions 243b1 and 243b2 not facing the positive electrode active material layer 243. Due to such facts, a phenomenon is observed that lithium ions are substantially transferred from the regions 243b1 and 243b2 not facing the positive electrode active material layer 223 to the region 243a facing the positive electrode active material layer 223.

### <<Measurement Method of Equilibrium Potential>>

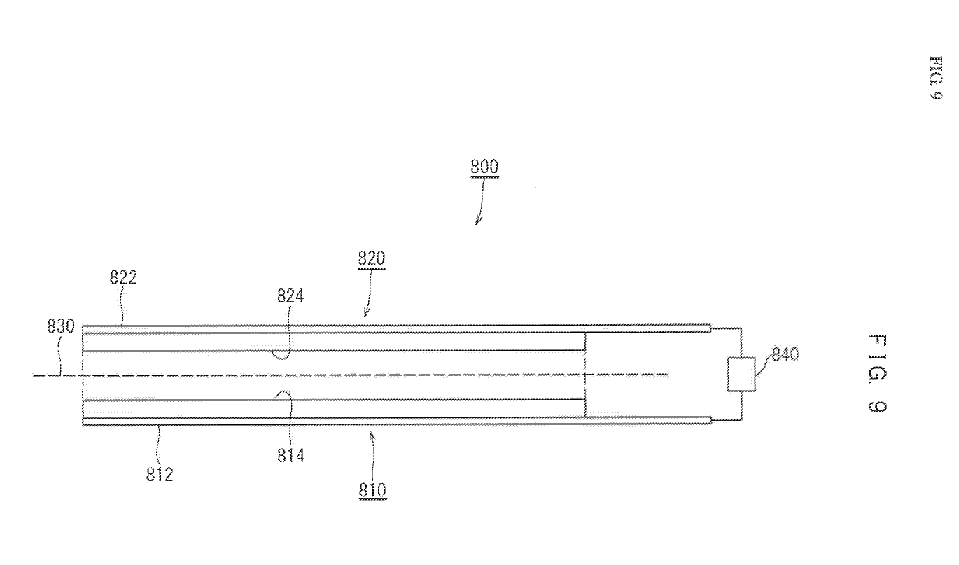

The equilibrium potential of the negative electrode active material layer may be obtained by, for example, a cyclic voltammogram. FIG. 9 shows an example of the configuration of an apparatus 800 for obtaining such a cyclic voltammogram. For example, in order to obtain such a cyclic voltammogram, a test electrode 810, which is the subject of measurement, and a reference electrode 820 are prepared, as illustrated in FIG. 9. In the test electrode 810 herein, an active material layer 814, which is the subject of evaluation, is formed on a current collector 812. The reference electrode 820 is an electrode in which metallic lithium 824 is retained by a current collector 822.

For the apparatus 800, a cell is prepared, as illustrated in FIG. 9, in which the active material layer 814, which is the subject of evaluation, and the reference electrode 820 are opposed to each other with a separator 830 interposed therebetween, and they are immersed in an electrolyte solution. A predetermined potential difference is imparted between the test electrode 810 and the reference electrode 820, and the test electrode 810 and the reference electrode 820 are connected to a measurement device 840 for obtaining a cyclic voltammogram. Then, the equilibrium potential may be defined by the mean value of the voltage values in the SOC-voltage profile during charge with a low current (e.g., 1/10C) and the SOC-voltage profile during discharge with the same conditions.

Herein, the same material as the negative electrode current collector 241 used for the negative electrode sheet 240 is used for the current collector 812 of the test electrode 810. In addition, the active material layers of the negative electrode active material layer 243 including the region 243a facing the positive electrode active material layer 223 and the regions 243b1 and 243b2 not facing the positive electrode active material layer 223 are replicated in the active material layer 814 of the test electrode 810.

That is, an electrode having an active material layer that is similar to the region 243a facing the positive electrode active material layer 223 in the active material layer 814 and an electrode having an active material layer that is similar to the regions 243b1 and 243b2 not facing the positive electrode active material layer 223 in the active material layer 814 are prepared herein as the electrode 810 that is the subject of measurement.

Next, using such an apparatus 800, an equilibrium potential is obtained for each sample of the test electrode 810 based on the cyclic voltammogram. Then, the equilibrium potential Ea of the region 243a facing the positive electrode active material layer 223 and the equilibrium potential Eb of the regions 243b1 and 243b2 not facing the positive electrode active material layer 223 may be estimated based on the equilibrium potential for each sample of test electrodes.

It should be noted here that the equilibrium potential varies depending on the state of charge of the cell. For this reason, the equilibrium potential should be estimated particularly taking into consideration the range of the state of charge (SOC) in which the lithium-ion secondary battery 100 is normally used. At this time, the cyclic voltammogram should be obtained taking into consideration the range of the potential that acts on the negative electrode active material layer 243 under the condition in which the lithium-ion secondary battery 100 is normally used. For example, the potential that is to be applied to the cell for obtaining the cyclic voltammogram should be determined taking into consideration the range of the potential that acts on the negative electrode active material layer 243 under the condition in which the lithium-ion secondary battery 100 is normally used. Then, the equilibrium potential of the region 243a facing the positive electrode active material layer 223 and the equilibrium potential of the regions 243b1 and 243b2 not facing the positive electrode active material layer 223 should be estimated based on such a cyclic voltammogram.

For this reason, it is desirable that the equilibrium potential Ea of the region 243a facing the positive electrode active material layer 223 is higher than the equilibrium potential Eb of the regions 243b1 and 243b2 not facing the positive electrode active material layer 223 (i.e., Ea>Eb) when the lithium-ion secondary battery 100 is at least within the range of state of charge in which the lithium-ion secondary battery 100 can be repeatedly charged and discharged. Thereby, lithium ions can be prevented from being fixed to the regions 243b1 and 243b2 not facing the positive electrode active material layer 223 more reliably.

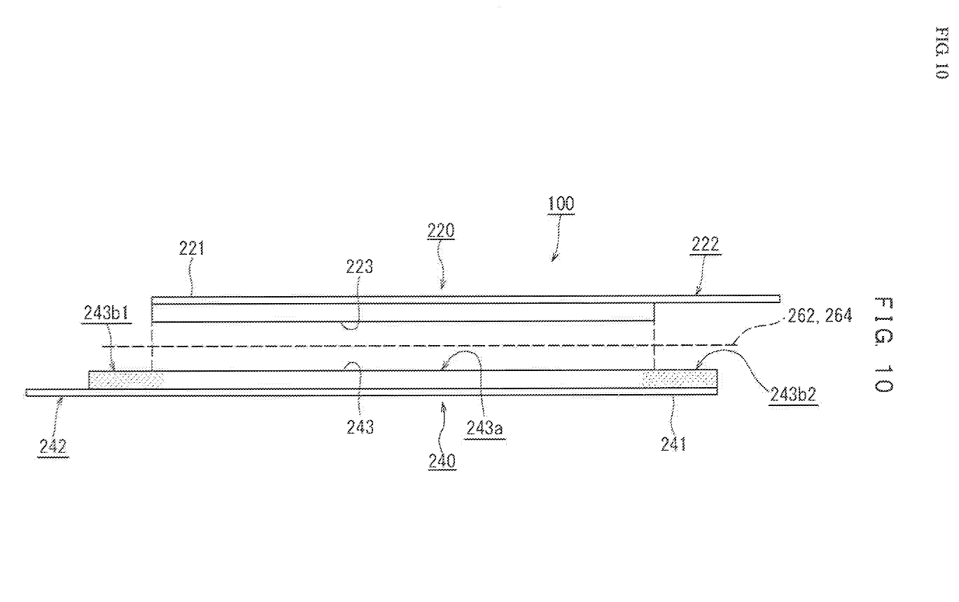

FIG. 10 schematically illustrates the structure of the lithium-ion secondary battery 100. FIG. 10 depicts a cross section of the negative electrode active material layer 243 and the positive electrode active material layer 223 in the wound electrode assembly 200 (see FIG. 1) taken along a widthwise direction (for example, a widthwise direction of the positive electrode sheet 220). Note that FIG. 10 depicts only one of the positive electrode active material layers 223 that is formed on one side of the positive electrode current collector 221. Likewise, FIG. 10 depicts only one of the negative electrode active material layers 243 that is formed on one side of negative electrode current collector 241. Also, the separators 262 and 264 are indicated simply by the dashed line.

In this embodiment, as previously described above, the widthwise intermediate portion of the negative electrode active material layer 243 faces the positive electrode active material layer 223, but both widthwise sides of the negative electrode active material layer 243 do not face the positive electrode active material layer 243. In order to show this point clearly, in FIG. 10, the width of the regions 243b1 and 243b2 not facing the positive electrode active material layer 223 is depicted greater than the actual width.

In this embodiment, the equilibrium potential Ea of the region 243a facing the positive electrode active material layer 223 is higher than the equilibrium potential Eb of the regions 243b1 and 243b2 not facing the positive electrode active material layer 223 (i.e., Ea>Eb) in the negative electrode active material layer 243. During discharge, the regions 243b1 and 243b2 not facing the positive electrode active material layer 223 (i.e., the regions in which the equilibrium potential is lower) tend to release lithium ions more easily than the region 243a facing the positive electrode active material layer 243 (i.e., the region in which the equilibrium potential is higher). In addition, during charge, the region 243a facing the positive electrode active material layer 223 tends to absorb lithium ions more easily than the regions 243b1 and 243b2 not facing the positive electrode active material layer 243. In addition, due to such facts, a phenomenon is observed that lithium ions are substantially transferred from the regions 243b1 and 243b2 not facing the positive electrode active material layer 223 to the region 243a facing the positive electrode active material layer 223.

With the lithium-ion secondary battery 100, the equilibrium potential Ea of the region 243a facing the positive electrode active material layer 223 is higher than the equilibrium potential Eb of the regions 243b1 and 243b2 not facing the positive electrode active material layer 223 (i.e., Ea>Eb) in the negative electrode active material layer 243.

This prevents the lithium ions absorbed in the regions 243b1 and 243b2 not facing the positive electrode active material layer 223 in the negative electrode active material layer 243 from being fixed to the regions 243b1 and 243b2 not facing the positive electrode active material layer 223. As a result, the lithium ions absorbed in the regions 243b1 and 243b2 not facing the positive electrode active material layer 223 can be utilized for the later battery reactions, so the decrease of the battery capacity is minimized.

The lithium-ion secondary battery 100 can prevent lithium ions from being fixed to the regions 243b1 and 243b2 not facing the positive electrode active material layer 223 more reliably, especially in such applications that it is repeatedly charged and discharged. Therefore, the lithium-ion secondary battery 100 can make the decrease of the battery capacity smaller even in such applications that it is repeatedly charged and discharged.

In this embodiment, each of the positive electrode current collector 221 and the negative electrode current collector 241 is in a strip-shaped sheet form. The positive electrode active material layer 223 is retained on the positive electrode current collector 221 so as to have a predetermined area. The negative electrode active material layer 243 is retained on the positive electrode current collector 221 so as to have a wider area than the positive electrode active material layer 223. The negative electrode active material layer 243 covers the positive electrode active material layer 223 while the separators 262 and 264 are interposed therebetween. This means that the regions 243b and 243b2 not facing the positive electrode active material layer 223 exist in the negative electrode active material layer 243.

The regions 243b1 and 243b2 not facing the positive electrode active material layer 223 can capture the lithium ions released from the positive electrode active material layer 223 more reliably. Therefore, deposition of lithium in the lithium-ion secondary battery 100 can be prevented more reliably. Moreover, the equilibrium potential Eb of the regions 243b1 and 243b2 not facing the positive electrode active material layer 223 is lower than the equilibrium potential Ea of the region 243a facing the positive electrode active material layer 223 (i.e., Ea>Eb). Therefore, even though the lithium-ion secondary battery 100 has the regions 243b1 and 243b2 not facing the positive electrode active material layer 223 in the negative electrode active material layer 243, lithium ions are unlikely to be fixed to the regions 243b1 and 243b2, and the battery capacity is unlikely to decrease.

In this embodiment, the region 243a facing the positive electrode active material layer 223 and the regions 243b1 and 243b2 not facing the positive electrode active material layer 223 comprise different negative electrode active materials from each other in the negative electrode active material layer 243. This provides a difference between the equilibrium potential Ea of the region 243a facing the positive electrode active material layer 223 and the equilibrium potential Eb of the regions 243b1 and 243b2 not facing the positive electrode active material layer 223 in the negative electrode active material layer 243.

It should be noted that, depending on the manufacturing method, it may be difficult to use completely different negative electrode active materials for the regions 243b1 and 243b2 not facing the positive electrode active material layer 223 and the region 243a facing the positive electrode active material layer 223.

In that case, it is desirable that a plurality of kinds of negative electrode active materials be used for the negative electrode active material layer 243. Specifically, the negative electrode active material layer 243 may use a negative electrode active material that contributes to relatively increasing the equilibrium potential and a negative electrode active material that contributes to relatively decreasing the equilibrium potential. Then, it is desirable that the proportion of the negative electrode active material that contributes to increasing the equilibrium potential Ea should be greater in the region 243a facing the positive electrode active material layer 223 than that in the regions 243b1 and 243b2 not facing the positive electrode active material layer 223. On the other hand, it is desirable that the proportion of the negative electrode active material that contributes to decreasing the equilibrium potential Ea should be less in the region 243a facing the positive electrode active material layer 223 than that in the regions 243b1 and 243b2 not facing the positive electrode active material layer 223.

In this case, for example, it is desirable that the weight ratio of the negative electrode active material that contributes to increasing the equilibrium potential Ea is 70 wt. % or higher (more preferably, 80 wt. % or higher, and still more preferably, 90 wt. % or higher) in the region 243a facing the positive electrode active material layer 223. In contrast, in the regions 243b1 and 243b2 not facing the positive electrode active material layer 223, it is desirable that the weight ratio of the negative electrode active material that contributes to decreasing the equilibrium potential Ea should be 70 wt. % or higher (more preferably, 80 wt. % or higher, and still more preferably, 90 wt. % or higher).

The equilibrium potential Ea of the region 243a facing the positive electrode active material layer 223 may desirably be evaluated, for example, at a region slightly away from the boundary between the region 243a facing the positive electrode active material layer 223 and the regions 243b1 and 243b2 not facing the positive electrode active material layer 223 (for example, at a region at least 5 mm away, more preferably, about 10 mm away therefrom).

### <<Negative Electrode Active Material Contained in the Negative Electrode Active Material Layer 243>>

By using different negative electrode active materials for the region 243a facing the positive electrode active material layer 223 and the regions 243b1 and 243b2 not facing the positive electrode active material layer 223 in this way, a difference arises in equilibrium potential. For the negative electrode active material of the lithium-ion secondary battery 100, it is possible to use graphites (carbon-based materials), such as natural graphite, artificial graphite, and amorphous carbon of natural graphite and artificial graphite. The graphites have different equilibrium potentials of the negative electrode active material layer depending on its type. Examples of the graphite that contributes to obtaining different equilibrium potentials in the negative electrode active material layer include graphitizable carbons (soft carbons), non-graphitizable carbons (hard carbons), and graphitic materials (graphites).

### <<Soft Carbon>>

Herein, graphitizable carbon refers to a carbon material that can be graphitized easily. An example of the graphitizable carbon is a carbon material obtained by heat-treating coke in a high-temperature atmosphere at about 1000° C. to about 2000° C. Such carbon materials have low mechanical strength, so they are also referred to as “soft carbons”.

### <<Hard Carbon>>

Non-graphitizable carbon refers to a carbon material that cannot be graphitized easily. In a non-graphitizable carbon, minute graphite crystals are disposed in random directions. Between the crystals, there are pores in a size of about several nanometers. A non-graphitizable carbon can be obtained by, for example, carbonizing a thermosetting resin. In the non-graphitizable carbon obtained by carbonizing a thermosetting resin, a graphite structure does not develop even when the heating temperature is set high. Examples of the non-graphitizable carbon used as a negative electrode active material include sintered materials of phenolic resins, sintered materials of furfuryl alcohol resins, polyacrylonitrile (PAN) based carbon fibers, quasi-isotropic carbons, and sintered materials of natural materials such as coffee bean and table sugar. Such carbon materials have higher mechanical strength than the above-described soft carbons, so they are also referred to as “hard carbons”.

### <<Graphitic Material>>

Graphitic material refers to a carbon material that has been graphitized. An example of the graphitic material is a carbon material obtained by heat-treating coke in a high-temperature atmosphere at about 2000° C. or higher (e.g., at about 2800° C.).

According to the present inventors' knowledge, the equilibrium potential of the negative electrode active material layer 243 becomes higher when a graphitizable carbon is used for the negative electrode active material than when a non-graphitizable carbon or a graphitic material is used for the negative electrode active material. When a non-graphitizable carbon is used for the negative electrode active material, the equilibrium potential of the negative electrode active material layer 243 becomes higher than when a graphitic material is used for the negative electrode active material.

Here, it is important to consider the equilibrium potential as determined when the lithium-ion secondary battery 100 is within the range of state of charge (SOC) in which the lithium-ion secondary battery 100 is normally used. For this reason, it is desirable that the equilibrium potential be evaluated when the secondary battery is within the range of state of charge in which the secondary battery can be repeatedly charged and discharged. For the cases that the graphitizable carbon, the non-graphitizable carbon, and the graphitic material are used for the negative electrode active material of the negative electrode active material layer, the equilibrium potentials of the negative electrode active material layers are compared when the secondary battery is within the just-mentioned range. It is evaluated that the equilibrium potential of the negative electrode active material layer is in the order: graphitizable carbon>non-graphitizable carbon>graphitic material, when the equilibrium potential of the negative electrode active material layer is evaluated in terms of the negative electrode active material used for the negative electrode active material layer with the lithium-ion secondary battery 100 being at a normal state of charge.

Therefore, for example, when a non-graphitizable carbon (hard carbon) is used for the negative electrode active material in the region 243a of the negative electrode active material layer 243 facing the positive electrode active material layer 223, it is desirable that a graphitic material be used for the negative electrode active material in the regions 243b1 and 243b2 of the negative electrode active material layer 243 not facing the positive electrode active material layer 223. On the other hand, when a graphitizable carbon (soft carbon) is used for the negative electrode active material in the region 243a of the negative electrode active material layer 243 facing the positive electrode active material layer 223, it is desirable that a non-graphitizable carbon or a graphitic material be used for negative electrode active material in the regions 243b1 and 243b2 of the negative electrode active material layer 243 not facing the positive electrode active material layer 223. Thereby, the region 243a of the negative electrode active material layer 243 facing the positive electrode active material layer 223 shows a higher equilibrium potential than the regions 243b1 and 243b2 not facing the positive electrode active material layer 223.

### <<Method of Forming Negative Electrode Active Material Layer 243>>

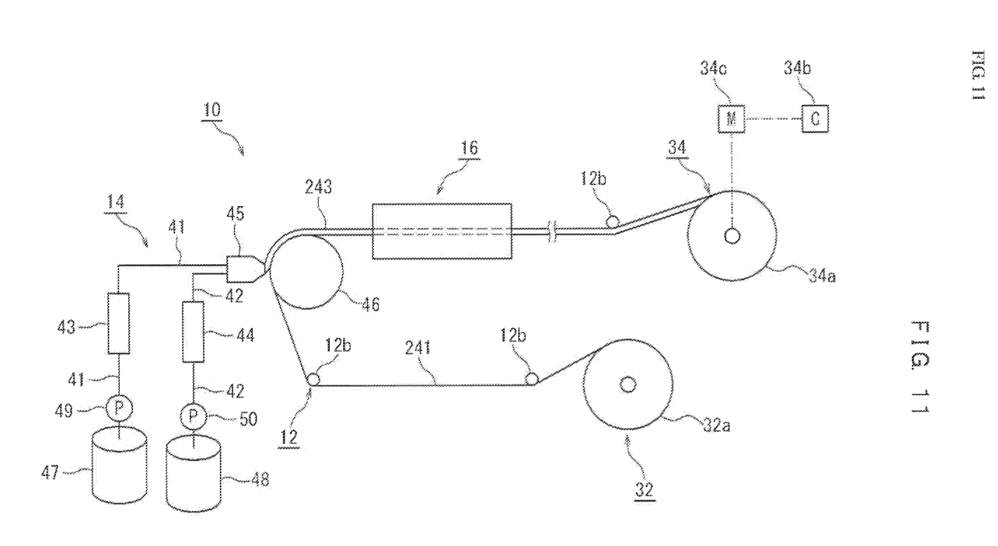

FIG. 11 is a view illustrating the process in which the negative electrode active material layer 243 is formed. As illustrated in FIG. 11, the negative electrode active material layer 243 is formed by coating a mixture containing a negative electrode active material onto the negative electrode current collector 241 with a predetermined width, followed by drying and thereafter pressure-rolling. As illustrated in FIG. 11, the manufacturing apparatus for forming the negative electrode active material layer 243 has a traveling path 12 in which the negative electrode current collector 241 is allowed to travel, a coating device 14 for coating the mixture that becomes the negative electrode active material layer 243 onto the negative electrode current collector 241, and a drying oven 16 for drying the mixture coated on the negative electrode current collector 241.

### <<Traveling Path 12>>

The traveling path 12 is a path in which the negative electrode current collector 241 is allowed to travel. In this embodiment, a plurality of guides 12b are disposed in the traveling path 12 along a predetermined path for conveying the negative electrode current collector 241. A supplying unit 32 for supplying the negative electrode current collector 241 is provided at the starting end of the traveling path 12. The negative electrode current collector 241 that has been wound around a winding core 32a in advance is disposed in the supplying unit 32. An appropriate amount of the negative electrode current collector 241 is supplied from the supplying unit 32 to the traveling path 12 as appropriate. A collecting unit 34 for collecting the negative electrode current collector 241 is provided at the trailing end of the traveling path 12. The collecting unit 34 winds the negative electrode current collector 241, which has been subjected to a predetermined treatment in the traveling path 12, around a winding core 34a.

In this embodiment, the collecting unit 34 is provided with, for example, a control unit 34b and a motor 34c. A program for controlling rotation of the winding core 34a of the collecting unit 34 is set in advance in the control unit 34b. The motor 34c is an actuator for driving and rotating the winding core 34a, and is driven by the program set in the control unit 34b. The electrode material coating device 14 and the drying oven 16 are disposed in that order in the traveling path 12.

### <<Electrode Material Coating Device 14 (Coating Process)>>

In this embodiment, in the wound electrode assembly 200 (see FIG. 2) later, the region 243a facing the positive electrode active material layer 223 and the regions 243b1 and 243b2 not facing the positive electrode active material layer 223 are allowed to contain different negative electrode active materials in their negative electrode active material layer 243. For this reason, the electrode material coating device 14 coats the region 243a facing the positive electrode active material layer 223 and the regions 243b1 and 243b2 not facing the positive electrode active material layer 223 with mixtures containing different negative electrode active materials.

As illustrated in FIG. 11, the electrode material coating device 14 has flow passages 41 and 42, filters 43 and 44, and a coating unit 45. In this embodiment, the electrode material coating device 14 is configured to apply a mixture to the negative electrode current collector 241 that travels on a back-roll 46 arranged in the traveling path 12. For this purpose, the electrode material coating device 14 further has tanks 47 and 48 and pumps 49 and 50. The tanks 47 and 48 are containers that respectively store different mixtures. The pumps 49 and 50 are devices that send out the mixtures from the tanks 47 and 48 to the flow passages 41 and 42.

### <<Flow Passages 41 and 42>>

The flow passages 41 and 42 are flow passages through which slurries containing negative electrode active materials dispersed in a solvent can flow. In this embodiment, the flow passages 41 and 42 are arranged from the tanks 47 and 48 to the coating unit 45. The filters 43 and 44 are disposed in the flow passages 41 and 42. In this embodiment, a first mixture used for forming a negative electrode active material layer that has a relatively high equilibrium potential and a second mixture used for forming a negative electrode active material layer that has a relatively low equilibrium potential are respectively prepared in the tanks 47 and 48. The first mixture and the second mixture have different types of negative electrode active materials contained in the solvent, as described above. In addition, it is preferable that the first mixture and the second mixture not easily mix with each other. For example, their solid content concentrations are adjusted.

### <<Coating Unit 45>>

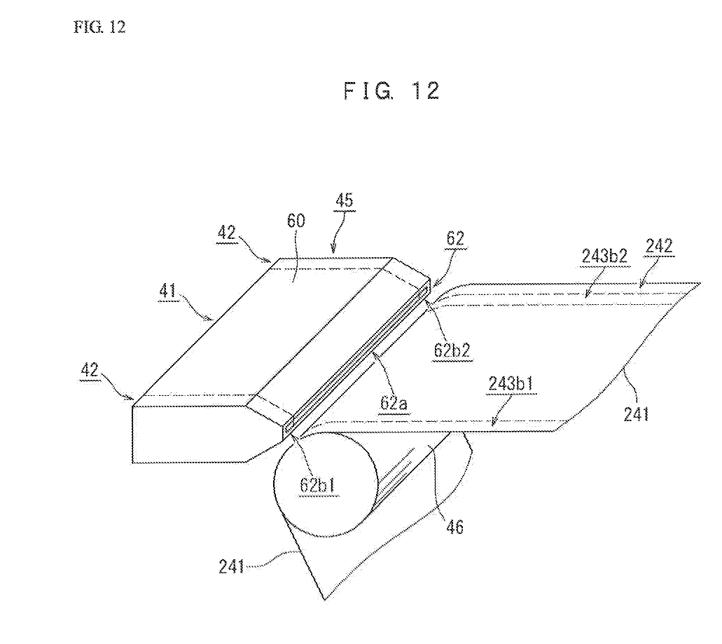

The coating unit 45 applies the first mixture containing a negative electrode active material having a higher equilibrium potential to the negative electrode current collector 241 for the region 243a facing the positive electrode active material layer 223. Also, the coating unit 45 applies the second mixture containing a negative electrode active material having a lower equilibrium potential to the negative electrode current collector 241 for the regions 243b1 and 243b2 not facing the positive electrode active material layer 223. In this embodiment, for example, a die 60 having a wide discharge port 62 is used in the coating unit 45, as illustrated in FIG. 12. The discharge port 62 of the die 60 is divided into an intermediate portion 62a and opposite side portions 62b1 and 62b2.

Flow passages respectively connected to the intermediate portion 62a and the opposite side portions 62b1 and 62b2 are formed inside the die 60. The intermediate portion 62a of the discharge port 62 is in communication with the flow passage 41 to which the first mixture is supplied. The opposite side portions 62b1 and 62b2 of the discharge port 62 are in communication with the flow passages 42 to which the second mixture is supplied. The first mixture is a mixture used for forming the negative electrode active material layer having a relatively high equilibrium potential. The second mixture is a mixture used for forming the negative electrode active material layer having a relatively low equilibrium potential. Accordingly, the intermediate portion 62a of the discharge port 62 discharges the first mixture used for forming the negative electrode active material layer having a relatively high equilibrium potential. On the other hand, the opposite side portions 62b1 and 62b2 of the discharge port 62 discharge the second mixture used for forming the negative electrode active material layer having a relatively low equilibrium potential.

The die 60 is disposed in such a manner that the intermediate portion 62a of the discharge port 62 to matches the region 243a so that the first mixture can be coated on the region 243a facing the positive electrode active material layer 223. At this time, the opposite side portions 62b1 and 62b2 of the discharge port 62 are matched with the regions 243b1 and 243b2 so that the second mixture can be coated on the regions 243b1 and 243b2 not facing the positive electrode active material layer 223.

This allows the first mixture to be coated onto the region 243a facing the positive electrode active material layer 223 and allows the second mixture to be coated onto the regions 243b1 and 243b2 not facing the positive electrode active material layer 223. Thus, the negative electrode current collector 241, in which the first mixture has been coated on the region 243a facing the positive electrode active material layer 223 and the second mixture has been coated on the regions 243b1 and 243b2 not facing the positive electrode active material layer 223, is supplied to the drying oven 16 (see FIG. 11).

This enables to form the negative electrode active material layer 243 as illustrated in FIG. 2, in which the equilibrium potential Ea of the region 243a facing the positive electrode active material layer 223 is higher than the equilibrium potential Eb of the regions 243b1 and 243b2 not facing the positive electrode active material layer 223 (i.e., Ea>Eb). Thus, the electrode material coating device 14 should desirably have a plurality of the discharge ports 62a, 62b1, and 62b2, which are divided from each other, and a plurality of flow passages 41 and 42 for supplying respective mixtures to the plurality of discharge ports 62a, 62b1, and 62b2.

### <<Experimental Evaluation>>

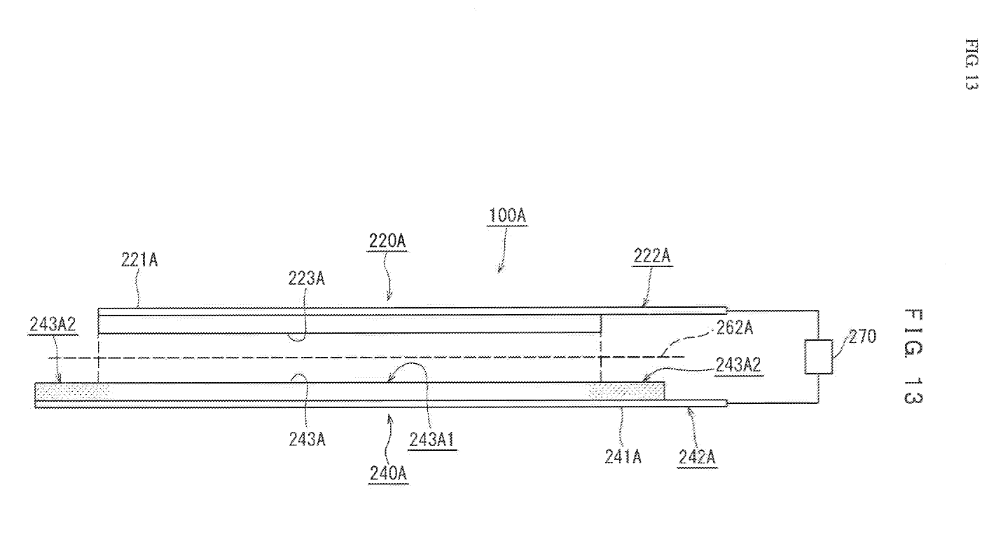

The present inventors conducted a test in order to evaluate the advantageous effects of the negative electrode sheet 240 such as described above. FIG. 13 shows a laminate-type test battery 100A used in the test. The test battery 100A has a positive electrode sheet 220A in which a positive electrode active material layer 223A is formed on one side of a positive electrode current collector 221A, and a negative electrode sheet 240A in which a negative electrode active material layer 243A is formed on one side of a negative electrode current collector 241A. The negative electrode active material layer 243A has a wider area than the positive electrode active material layer 223A. The negative electrode active material layer 243A faces the positive electrode active material layer 223A although a separator 262A is interposed therebetween. The positive electrode current collector 221A and the negative electrode current collector 241A have respective uncoated portions 222A and 242A. The positive electrode current collector 221A and the negative electrode current collector 241A are connected to a measurement device 270 via the uncoated portions 222A and 242A.

Herein, the electrical capacity of the negative electrode active material layer 243A was adjusted relative to the positive electrode active material layer 223A of the positive electrode sheet 220A so that the ratio of the theoretical capacity of the positive electrode and the theoretical capacity of the negative electrode became 1:1.5. Herein, the positive electrode active material layer 223 was in a 5 cm×5 cm square shape, and the negative electrode active material layer 243A was in a 9 cm×9 cm square shape. Then, the positive electrode active material layer 223 and the negative electrode active material layer 243A were stacked on each other so that 2-cm non-facing regions were formed both longitudinally and transversely.

### <<Positive Electrode Sheet 220A>>

Here, in the positive electrode sheet 220A, LiFePO₄ is used as the positive electrode active material contained in the positive electrode active material layer 223. Acetylene black (AB) was used as the conductive agent, and PVDF was used as the binder agent. A mixture in which LiFePO₄, AB, and PVDF were mixed in a weight ratio of LiFePO₄: AB:PVDF=85:5:10 using NMP as a dispersion medium was prepared as the mixture for forming the positive electrode active material layer 223A. Then, the resultant mixture was applied onto an aluminum foil serving as the positive electrode current collector 221A, and the resultant material was dried and rolled by roll pressing, to form the positive electrode sheet 220A.

### <<Separator 262A and Electrolyte Solution>>

A porous film made of a composite material of polypropylene and polyethylene is used for the separator 262A. Also, an electrolyte solution is used in which ethylene carbonate and ethyl methyl carbonate are mixed at a volume ratio of 5:5 and 1 mole of LiPf is dissolved therein.

### <<Negative Electrode Sheet 240A>>

For the negative electrode sheet 240A, a plurality of samples (e.g., samples 1 through 7 in Table 1) were formed by varying the negative electrode active materials contained in the region 243A1 of the negative electrode active material layer 243A facing the positive electrode active material layer 223A and the regions 243A2 thereof not facing the positive electrode active material layer 223A.

TABLE 1

| | Region facing | Region not facing | Capacity |
|---|---|---|---|
| | positive electrode | positive electrode | retention |
| | active material layer | active material layer | ratio (%) |
| Sample 1 | Graphitic material | Graphitic material | 83 |
| Sample 2 | Graphitizable carbon | Graphitizable carbon | 84 |
| Sample 3 | Non-graphitizable | Non-graphitizable | 84 |
| | carbon | carbon | |
| Sample 4 | Graphitic material | Non-graphitizable | 82 |
| | | carbon | |
| Sample 5 | Graphitizable carbon | Graphitic material | 92 |
| Sample 6 | Non-graphitizable | Graphitic material | 91 |
| | carbon | | |
| Sample 7 | Graphitizable carbon | Non-graphitizable | 91 |
| | | carbon | |

For the mixture for forming the negative electrode active material layer 243A, styrene-butadiene copolymer (SBR) was used as the binder agent, carboxymethylcellulose (CMC) was used as the thickening agent, and water was used as the solvent. In addition, a plurality of types of appropriate carbon materials were prepared as the negative electrode active materials. Herein, as the negative electrode active material, a carbon material, a binder agent (SBR), and a thickening agent (CMC) were mixed with a water as the solvent in a predetermined weight ratio. Here, the weight ratio of the carbon material, SBR, and CMC was set at carbon material:SBR:CMC=95:2.5:2.5. Then, the resultant mixture was applied onto a copper foil serving as the negative electrode current collector 241, and the resultant material was dried and rolled by roll pressing, to form the negative electrode sheet 240A.

### <<Samples 1-7>>

Samples 1 through 7 have different negative electrode active materials contained in the region 243A1 of the negative electrode active material layer 243A facing the positive electrode active material layer 223A and the regions 243A2 of the negative electrode active material layer 243A not facing the positive electrode active material layer 223A. Samples 1 through 7 have the same configuration except for the negative electrode active materials contained in the regions 243A1 and 243A2.

In sample 1, both the negative electrode active materials contained in the region 243A1 of the negative electrode active material layer 243A facing the positive electrode active material layer 223A and the regions 243A2 of the negative electrode active material layer 243A not facing the positive electrode active material layer 223A are graphitic material (graphite-based carbon material).

In sample 2, both the negative electrode active materials contained in the region 243A1 of the negative electrode active material layer 243A facing the positive electrode active material layer 223A and the regions 243A2 of the negative electrode active material layer 243A not facing the positive electrode active material layer 223A are graphitizable carbon.

In sample 3, both the negative electrode active materials contained in the region 243A1 of the negative electrode active material layer 243A facing the positive electrode active material layer 223A and the regions 243A2 of the negative electrode active material layer 243A not facing the positive electrode active material layer 223A are non-graphitizable carbon.

In each of samples 1 through 3, the negative electrode active material contained in the region 243A1 of the negative electrode active material layer 243A facing the positive electrode active material layer 223A and that contained in the regions 243A2 of the negative electrode active material layer 243A not facing the positive electrode active material layer 223A are the same. Consequently, there is almost no difference between the equilibrium potential Ea of the region 243A1 of the negative electrode active material layer 243A facing the positive electrode active material layer 223A and the equilibrium potential Eb of the regions 243A2 of the negative electrode active material layer 243A not facing the positive electrode active material layer 223A (i.e., Ea=Eb).

In sample 4, the negative electrode active material contained in the region 243A1 of the negative electrode active material layer 243A that faces the positive electrode active material layer 223A is graphitic material. On the other hand, the negative electrode active material contained in the regions 243A2 of the negative electrode active material layer 243A not facing the positive electrode active material layer 223A is non-graphitizable carbon. In this sample 4, the equilibrium potential Ea of the region 243A1 of the negative electrode active material layer 243A facing the positive electrode active material layer 223A is lower than the equilibrium potential Eb of the regions 243A2 not facing the positive electrode active material layer 223A (i.e., Eb>Ea).

Conversely, in sample 5, the negative electrode active material contained in the region 243A1 of the negative electrode active material layer 243A that faces the positive electrode active material layer 223A is graphitizable carbon. On the other hand, the negative electrode active material contained in the regions 243A2 of the negative electrode active material layer 243A not facing the positive electrode active material layer 223A is graphitic material. In this sample 5, the equilibrium potential Ea of the region 243A1 of the negative electrode active material layer 243A facing the positive electrode active material layer 223A is higher than the equilibrium potential Eb of the regions 243A2 of the negative electrode active material layer 243A not facing the positive electrode active material layer 223A (i.e., Ea>Eb).

In sample 6, the negative electrode active material contained in the region 243A1 of the negative electrode active material layer 243A that faces the positive electrode active material layer 223A is non-graphitizable carbon. On the other hand, the negative electrode active material contained in the regions 243A2 of the negative electrode active material layer 243A not facing the positive electrode active material layer 223A is graphitic material. In this sample 6, the equilibrium potential Ea of the region 243A1 of the negative electrode active material layer 243A facing the positive electrode active material layer 223A is higher than the equilibrium potential Eb of the regions 243A2 of the negative electrode active material layer 243A not facing the positive electrode active material layer 223A (i.e., Ea>Eb).

In sample 7, the negative electrode active material contained in the region 243A1 of the negative electrode active material layer 243A that faces the positive electrode active material layer 223A is graphitizable carbon. On the other hand, the negative electrode active material contained in the regions 243A2 of the negative electrode active material layer 243A not facing the positive electrode active material layer 223A is non-graphitizable carbon. In this sample 7, the equilibrium potential Ea of the region 243A1 of the negative electrode active material layer 243A facing the positive electrode active material layer 223A is higher than the equilibrium potential Eb of the regions 243A2 not facing the positive electrode active material layer 223A (i.e., Ea>Eb).

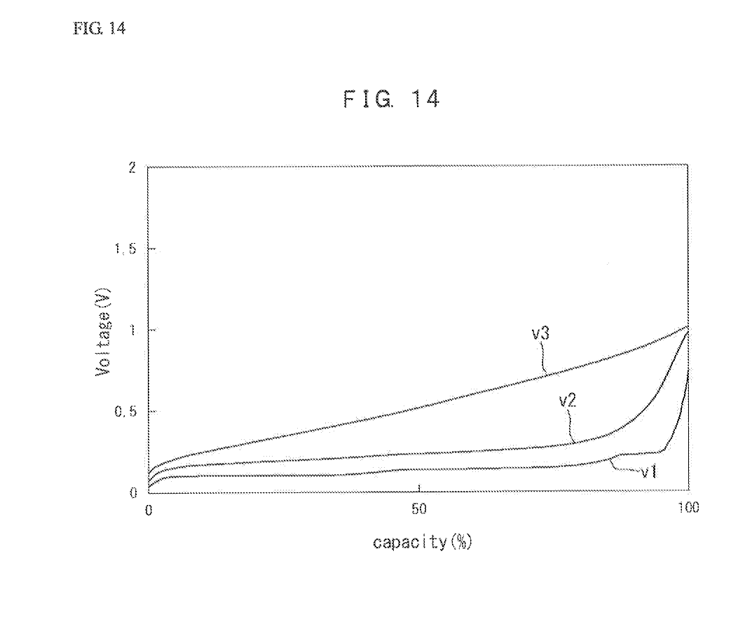

FIG. 14 shows the equilibrium potential v1 of the negative electrode active material layer using graphitic material as the negative electrode active material, the equilibrium potential v2 of the negative electrode active material layer using non-graphitizable carbon as the negative electrode active material, and the equilibrium potential v3 of the negative electrode active material layer using graphitizable carbon as the negative electrode active material. In FIG. 14, metallic lithium is used as the reference electrode, and the horizontal axis represents state of charge while the vertical axis represents equilibrium potential. The method of measuring the equilibrium potential here follows the example illustrated in FIG. 9. For the graphitizable carbon, the non-graphitizable carbon, and the graphitic material used here, the materials that cause a difference of 0.1 V or greater in equilibrium potential of the negative electrode active material layer were selectively used.

<<Evaluation Method>>

Here, each of the test batteries of samples 1 through 7 were charged and discharged at a constant current, as the initial process (conditioning process). Thereafter, each of the test batteries was charged at a constant current with a current value of ⅓ of the battery capacity estimated from the theoretical capacity of positive electrode (for example, with 100 mA when the estimated battery capacity is 300 mAh) to the end-of-charge voltage (for example, to 4.1 V). Further, the test cells were charged at a constant voltage until the final current value became 1/10 of the current value at the initial stage.

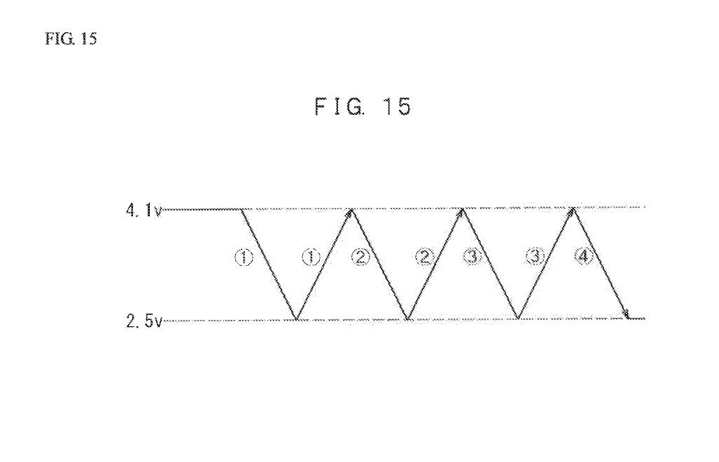

Next, FIG. 15 is a view illustrating the process for measuring the cell capacity in such an evaluation test. As illustrated in FIG. 15, each of the test batteries was repeatedly charged and discharged 3 times at a current value (100 mA) that was ⅓ of the battery capacity estimated from the positive electrode theoretical capacity. At this time, the end-of-charge voltage was set at 4.1 V, and the end-of-discharge voltage was set at 2.5 V. Then, the capacity obtained at the 4th time discharge was defined as the initial cell capacity.

Next, each of the test cells was placed in a thermostatic chamber with an atmosphere of 60° C., and was repeatedly charged and discharged 1000 times with a current value of 3 times of the battery capacity estimated from the theoretical capacity of positive electrode (for example, 900 mA when the estimated battery capacity is 300 mAh). The 1000th cycle was finished with the charged state. Thereafter, as illustrated in FIG. 15, each of the test cells was repeatedly charged and discharged 3 times at a current value (100 mA) that was ⅓ of the battery capacity estimated from the positive electrode theoretical capacity, and the discharge capacity obtained at the 4th time discharge was defined as the post-deterioration cell capacity. Then, the capacity retention ratio (%) was obtained by dividing the post-deterioration cell capacity by the initial cell capacity.

As a result, the capacity retention ratio (%) was about 82% to 84% for samples 1 through 3, in which there is almost no difference between the equilibrium potential Ea of the region 243A1 facing the positive electrode active material layer 223A and the equilibrium potential Eb of the regions 243A2 not facing the positive electrode active material layer 223A, and for sample 4, in which the equilibrium potential Ea of the region 243A1 facing the positive electrode active material layer 223A is lower than the equilibrium potential Eb of the regions 243A2 not facing the positive electrode active material layer 223A.

In contrast, in samples 5 through 7, the equilibrium potential Ea of the region 243A1 facing the positive electrode active material layer 223A is higher than the equilibrium potential Eb of the regions 243A2 not facing the positive electrode active material layer 223A (i.e., Ea>Eb). These samples 5 through 7 yielded remarkably better results, capacity retention ratios of about 91% to about 92%.

Thus, the capacity retention ratio of the lithium-ion secondary battery 100 is improved when the equilibrium potential Ea of the region 243A1 facing the positive electrode active material layer 223A is higher than the equilibrium potential Eb of the regions 243A2 not facing the positive electrode active material layer 223A (i.e., Ea>Eb). According to the findings of the present inventors, such an advantageous effect can be obtained more significantly when, preferably, there is a difference of 0.1 V between the equilibrium potential Ea of the region 243A1 facing the positive electrode active material layer 223A and the equilibrium potential Eb of the regions 243A2 not facing the positive electrode active material layer 223A.

Hereinabove, the secondary battery according to one embodiment of the present invention has been described. However, the secondary battery according to the present invention is not limited to the embodiments described above. The present invention is not limited to any of the embodiments described above unless otherwise stated.

### <<Other Battery Constructions>>

Cylindrical batteries and laminate-type batteries, for example, are known as other types of battery constructions. The cylindrical battery is a battery in which a wound electrode assembly is enclosed in a cylindrical battery case. The laminate-type battery is a battery in which positive electrode sheets and negative electrode sheets are stacked on each other with separators interposed therebetween.

In addition, as described above, the present invention can contribute to improvements in capacity retention ratio of secondary batteries (for example, lithium-ion secondary batteries). Therefore, the present invention is suitable for lithium-ion secondary batteries for vehicle-driving power sources, such as drive batteries for hybrid electric vehicles and electric vehicles, in which a particularly high level of capacity retention ratio over long-term use is required. For example, the lithium-ion secondary battery can be suitably used as a battery 1000 for driving a motor (electric motor) of a vehicle 1 such as an automobile. The vehicle drive battery 1000 may be a battery module in which a plurality of secondary batteries are combined.

### REFERENCE SIGNS LIST

1—Vehicle
12—Traveling path
14—Electrode material coating device
16—Drying oven
32—Supplying unit
32a—Winding core
34—Collecting unit
34a—Winding core
34b—Control unit
34c—Motor
41, 42—Flow passage
43, 44—Filter
45—Coating unit
46—Back-roll
47, 48—Tank
49, 49—Pump
60—Die
62—Discharge port
62a—Intermediate portion (discharge port)
62b1, 62b2—Opposite side portions (discharge port)
100—Lithium-ion secondary battery
100A—Test battery
200—Wound electrode assembly
220, 220A—Positive electrode sheet
221, 221A—Positive electrode current collector
222, 222A—Uncoated portion
224—Intermediate portion of uncoated portion 222
223, 223A—Positive electrode active material layer
240, 240A—Negative electrode sheet
241, 241A—Negative electrode current collector
242, 242A—Uncoated portion
243, 243A—Negative electrode active material layer
243a, 243A1—Region facing positive electrode active material layer
243b1, 243b2, 243A2—Region not facing positive electrode active material layer
244—Intermediate portion of uncoated portion 242
262, 262A, 264—Separator
270—Measurement device
280—Electrolyte solution
290—Charger
300—Battery case
310—Gap
320—Case main body
322—Joint portion between lid and case main body
340—Lid
360—Safety vent
420—Electrode terminal (positive electrode)
440—Electrode terminal (negative electrode)
610—Positive electrode active material
620—Conductive agent
630—Binder
710—Negative electrode active material
730—Binder
800—Apparatus
810—Test electrode
812—Current collector
814—Active material layer
820—Reference electrode
822—Current collector
824—Metallic lithium
830—Separator
840—Measurement device
1000—Vehicle drive battery

1. A secondary battery comprising:
a positive electrode current collector;
a positive electrode active material layer retained on the positive electrode current collector;
a negative electrode current collector;
a negative electrode active material layer retained on the negative electrode current collector and covering the positive electrode active material layer; and
a separator interposed between the positive electrode active material layer and the negative electrode active material layer, wherein
the negative electrode active material layer comprises a region facing the positive electrode active material layer and a region not facing the positive electrode active material layer, the region facing the positive electrode active material layer having an equilibrium potential Ea and the region not facing the positive electrode active material layer having an equilibrium potential Eb, and the equilibrium potential Ea is higher than the equilibrium potential Eb (Ea>Eb).

2. The secondary battery according to claim 1, wherein in the negative electrode active material layer, the region facing the positive electrode active material layer and the region not facing the positive electrode active material layer comprise different negative electrode active materials.

3. The secondary battery according to claim 1, wherein the equilibrium potential Ea is higher than the equilibrium potential Eb (Ea>Eb) at least when the secondary battery is within the range of state of charge in which the secondary battery can be repeatedly charged and discharged.

4. The secondary battery according to claim 1, wherein:
each of the positive electrode current collector and the negative electrode current collector is in a strip-shaped sheet form;
the positive electrode active material layer is retained on the positive electrode current collector so as to have a predetermined width; and
the negative electrode active material layer is retained on the negative electrode current collector so as to have a width wider than the positive electrode active material layer.

5. A battery module comprising a plurality of the secondary batteries according to claim 1.

6. A vehicle incorporating the secondary battery claim 1.

7. A vehicle incorporating the secondary battery module according to claim 5.
